(19) United States
(12) Patent Application Publication
(10) Pub. No.: US 2026/0164147 A1
(43) Pub. Date: Jun. 11, 2026

(54) CURRENT MIRROR READOUT FOR SILICON PHOTOMULTIPLIER

(71) Applicant: SEMICONDUCTOR COMPONENTS INDUSTRIES, LLC, Scottsdale, AZ (US)

(72) Inventors: Vincenzo SESTA, Cork (IE); Krishn KUMAR, Nawada (IN); Sanjay Kumar SINGH, Mankapur Gonda (IN)

(73) Assignee: SEMICONDUCTOR COMPONENTS INDUSTRIES, LLC, Scottsdale, AZ (US)

(21) Appl. No.: 18/973,789

(22) Filed: Dec. 9, 2024

(51) Int. Cl. H04N 25/773

(52) U.S. Cl. CPC H04N 25/773

(57) ABSTRACT

A silicon photomultiplier (SiPM) is disclosed. The SiPM includes a plurality of microcells coupled to a summation node of the SiPM. Each of the plurality of microcells comprises a single-photon avalanche diode and a passive quenching device coupled in series with the single-photon avalanche diode. Each of the plurality of microcells also comprises a current mirror configured to generate a microcell output current based on a current from the single-photon avalanche diode.

### TECHNICAL FIELD

The disclosure relates generally to imaging systems, and particularly to imaging sensors that include a silicon photomultiplier (SiPM) consisting of multiple single-photon avalanche diodes (SPADs).

### BACKGROUND

Modern electronic devices such as cellular telephones, cameras, and computers often use digital image sensors. Image sensors, which may also be referred to as imagers, may be formed from a two-dimensional array of image sensing pixels. In depth imaging applications, single-photon devices may be implemented to detect photons transmitted from a source and reflected from a target and to measure a precise target distance based on the time-of-flight (ToF) information for that photon. For example, a single-photon device may include an array of silicon photomultiplier (SiPM) devices. Each SiPM device may in turn consist of multiple single-photon avalanche diodes (SPADs). The multiple SPADs of an SiPM device may form the light-sensitive area of the SiPM and may provide an analog output signal.

The inventors of embodiments of the present disclosure have recognized that grouping together multiple SPADs into a single SiPM may cause voltage drops across the metal lines routing the common bias or common output lines of the SiPM. The inventors of embodiments of the present disclosure have also recognized that such voltage drops may lead to a degradation of the photon detection efficiency (PDE) uniformity across the SiPM and the imaging system in which the SiPM may be implemented. Embodiments of the present disclosure may address one or more of these challenges.

### BRIEF DESCRIPTION OF THE DRAWINGS

A more complete understanding of the present embodiments may be acquired by referring to the following description taken in conjunction with the accompanying drawings, in which like reference numbers indicate like features.

FIG. 1 illustrates a schematic block diagram of an example imaging system with a SPAD-based semiconductor device in accordance with embodiments of the present disclosure.

FIG. 2 illustrates a schematic block diagram of an example positron emission tomography (PET) imaging system with a SPAD-based semiconductor device in accordance with embodiments of the present disclosure.

FIG. 3 illustrates a block diagram of a pixel array and associated readout circuitry for reading out image signals in an example SPAD-based semiconductor device in accordance with embodiments of the present disclosure.

FIG. 4 illustrates a circuit diagram of a silicon photomultiplier (SiPM) in accordance with embodiments of the present disclosure.

FIG. 5 illustrates a circuit diagram of a silicon photomultiplier (SiPM) in accordance with embodiments of the present disclosure.

FIG. 6 illustrates a circuit diagram of a silicon photomultiplier (SiPM) in accordance with embodiments of the present disclosure.

FIG. 7 illustrates a circuit diagram of a silicon photomultiplier (SiPM) in accordance with embodiments of the present disclosure.

FIG. 8 illustrates example waveforms of signals within a SPAD-based microcell in accordance with embodiments of the present disclosure.

### DETAILED DESCRIPTION

Details of one or more embodiments are set forth in the description below and the accompanying drawings. Other features will be apparent from the description, drawings, and from the claims. The embodiments disclosed should not be interpreted, or otherwise used, as limiting the scope of the disclosure, including the claims. In addition, one skilled in the art understands that the following description has broad application, and the discussion of any embodiment is meant to be exemplary of that embodiment, and not intended to intimate that the scope of the disclosure, including the claims, is limited to that embodiment.

Various terms are used to refer to particular system components. Different companies may refer to a component by different names, and this disclosure does not intend to distinguish between components that differ in name but not form and function. In the following discussion and in the claims, the terms “including” and “comprising” are used in an open-ended fashion, and thus should be interpreted to mean “including, but not limited to.” Also, the term “couple” or “coupled” is intended to mean either a direct or an indirect connection. Thus, if a first device is coupled to a second device, the connection between the first device and the second device may be through a direct connection or through an indirect connection via other devices and/or connections.

Imaging systems may include image sensors that sense light by converting impinging photons of light into pairs of electrons and holes that are collected in pixel photodiodes within the sensor array. After completion of an integration cycle, collected charge may be converted into a voltage, which is supplied to the output terminals of the sensor. In complementary metal-oxide semiconductor (CMOS) image sensors, the charge to voltage conversion may be accomplished directly in the pixels themselves and the analog pixel voltage may be transferred to the output terminals through various pixel addressing and scanning schemes. The analog pixel voltage can also be later converted on-chip to a digital equivalent and processed in various ways in the digital domain.

In single-photon avalanche diode (SPAD) devices, on the other hand, the photon detection principle is different. The light sensing diode may be biased slightly above its reverse breakdown voltage, and when an incident photon generates an electron and hole pair, the electron or hole carrier drifts to the multiplication region and it may initiate an avalanche breakdown with additional carriers being generated. The avalanche multiplication may produce a current signal that may be detected by readout circuitry associated with the single-photon avalanche diode. The avalanche process may subsequently be stopped or quenched by lowering the bias below or equal to the reverse breakdown voltage of the diode. Each single-photon avalanche diode may therefore include a passive and/or active quenching circuit for quenching the avalanche by lowering the bias.

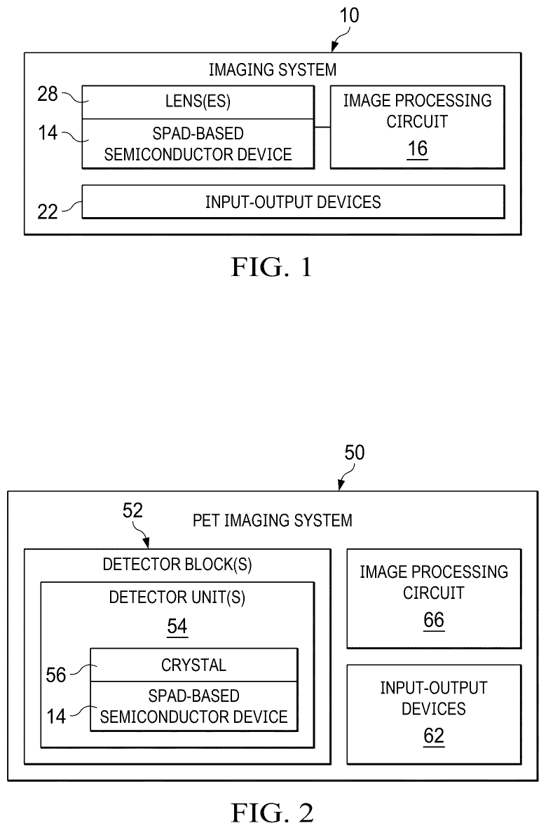

SPAD devices may be used in multiple ways. For example, in low light level applications, the arriving photons may simply be counted. As another example, SPAD devices may be used to measure photon time-of-flight (ToF) from a synchronized light source to a scene object point and back to the sensor, which may be used to obtain a three-dimensional image of the scene. As described in further detail below with reference to FIG. 1 and FIG. 2, SPAD-based semiconductor devices may be used, for example, in both LIDAR and PET imaging applications.

FIG. 1 illustrates a schematic block diagram of imaging system 10 with SPAD-based semiconductor device 14 in accordance with embodiments of the present disclosure. In some embodiments, imaging system 10 may be an electronic device such as a digital camera, a computer, a cellular telephone, a medical device, or other electronic device. Imaging system 10 may also be an imaging system of a vehicle. In some embodiments, imaging system 10 may be used for LIDAR applications. Imaging system 10 may include one or more SPAD-based semiconductor devices 14, which may also be referred to as devices, semiconductor devices, image sensors, or SPAD-based image sensors. One or more lenses 28 may optionally cover each SPAD-based semiconductor device 14. During operation, lenses 28 may focus light onto one or more instance of SPAD-based semiconductor device 14. SPAD-based semiconductor device 14 may include SPAD-based image pixels that may convert incident light into digital data. SPAD-based semiconductor device 14 may have any suitable number of SPAD-based image pixels, such as one hundred, one thousand, one million, or more.

SPAD-based semiconductor device 14 may optionally include additional circuitry. For example, SPAD-based semiconductor device 14 may include bias circuitry such as source follower load circuits. As other examples, SPAD-based semiconductor device 14 may also include one or more of sample and hold circuitry, amplifier circuitry, analog-to-digital converter (ADC) circuitry, time-to-digital converter (TDC) circuitry, data output circuitry, address circuitry, and/or buffer circuitry and memory.

SPAD-based semiconductor device 14 may be communicatively coupled to image processing circuit 16. Image data from SPAD-based semiconductor device 14 may thus be provided to image processing circuit 16. Image processing circuit 16 may perform image processing functions including, but not limited to, automatic focusing functions, depth sensing, data formatting, adjusting white balance and exposure, implementing video image stabilization, and/or face detection. For example, during automatic focusing operations, image processing circuit 16 may process data gathered by the SPAD-based image pixels to determine the magnitude and direction of movement of one or more lenses 28 needed to bring an object of interest into focus. Image processing circuit 16 may process data gathered by the SPAD-based image pixels to determine a depth map of the scene.

Imaging system 10 may provide a user with numerous high-level functions. In a computer or advanced cellular telephone, for example, a user may be provided with the ability to run user applications. To implement these functions, imaging system 10 may include input-output devices 22 such as keypads, buttons, input-output ports, joysticks, and/or displays. Additional storage and processing circuitry such as volatile and nonvolatile memory, microprocessors, microcontrollers, digital signal processors, application specific integrated circuits, and/or other processing circuits may also be included in imaging system 10.

Input-output devices 22 may include output devices that work in combination with SPAD-based semiconductor device 14. For example, a light-emitting component may be included in the imaging system to emit light, such as infrared light or light of any other desired type. SPAD-based semiconductor device 14 may measure the reflection of the light off of an object to measure distance to the object in a light detection and ranging (LIDAR) scheme.

FIG. 2 illustrates a schematic block diagram of an example positron emission tomography (PET) imaging system 50 that includes a SPAD-based semiconductor device 14 in accordance with embodiments of the present disclosure. In some embodiments, PET imaging system 50 may be a medical device such as a PET scanner or other electronic device. PET imaging system 50 may also be referred to as a SPAD-based imaging system or a SPAD-based PET imaging system.

PET imaging system 50 may include one or more detector blocks 52. Each detector block 52 may include one or more detector units 54. Each detector unit 54 may include a respective SPAD-based semiconductor device 14 and crystal 56. Crystal 56 may also be referred to as a scintillator. Crystal 56 may absorb ionizing radiation such as gamma rays caused, for example, by a radioactive tracer used in the PET imaging system. In response to the gamma rays, crystal 56 may emit light in the visible spectrum. For example, crystal 56 may emit blue light in response to the absorption of gamma rays. Crystal 56 may be formed with lutetium-yttrium oxyorthosilicate (LYSO), or any material suitable to serve as a scintillator.

One or more lenses may optionally cover each SPAD-based semiconductor device 14. During operation, lenses may focus light from crystal 56 onto SPAD-based semiconductor device 14. SPAD-based semiconductor device 14 may include SPAD-based image pixels, which may convert light from crystal 56 into digital data. In some embodiments, one or more blue-pass filters may also be used to pass wavelengths of blue light and to block infrared and other wavelengths of visible light. For example, a universal blue-pass filter may be included within detector block 52 of PET imaging system 50 to pass wavelengths of blue light and to block infrared and other wavelengths of visible light from reaching SPAD-based semiconductor device 14.

Image data from SPAD-based semiconductor device 14 may be provided to image processing circuit 66. Image processing circuit 66 may be used to perform image processing functions for PET imaging system 50. In some cases, some or all of the control circuitry within PET imaging system 50 may be formed integrally with image processing circuit 66. Further, PET imaging system 50 may provide a user with numerous high-level functions. To implement these functions, PET imaging system 50 may include one or more input-output devices 62 such as keypads, buttons, input-output ports, joysticks, and displays such as touch-sensitive displays. Additional storage and processing circuitry such as volatile and nonvolatile memory, microprocessors, microcontrollers, digital signal processors, application specific integrated circuits, and/or other processing circuits may also be included in PET imaging system 50.

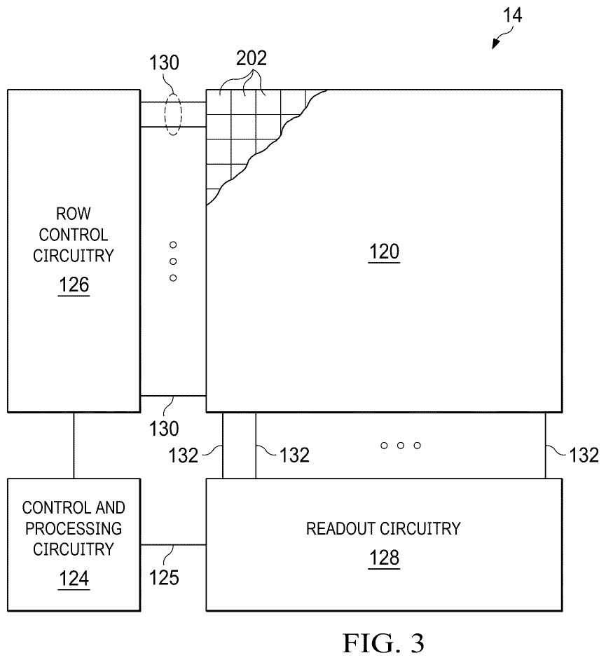

FIG. 3 illustrates a block diagram of a pixel array and associated readout circuitry for reading out image signals in an example SPAD-based semiconductor device 14 in accordance with embodiments of the present disclosure. As shown in FIG. 3, SPAD-based semiconductor device 14 may include an array 120 of SPAD-based image pixels 202 arranged in rows and columns. Array 120 may contain, for example, hundreds or thousands of rows and columns of SPAD-based image pixels 202. In some embodiments, each SPAD-based image pixel 202 may be coupled to an analog pulse counter, for example, which may generate a corresponding pixel voltage based on received photons. In other embodiments, each SPAD-based image pixel 202 may be coupled to a digital pulse counter whose digital output code may correspond to the number of photons in a defined time window. Each SPAD-based image pixel 202 may additionally or alternatively be coupled to a time-of-flight to voltage converter circuit. In both types of readout circuits, voltages may be stored on pixel capacitors and may later be scanned in a row-by-row fashion, or digital code may be stored in memory and may later be scanned in a row-by-row fashion. In the case of an SiPM device, both types of readout circuits may be coupled to the output of image pixel, which may be formed by multiple SPAD-based microcells and connected together to form the single output pixel. Control and processing circuitry 124 may be coupled to row control circuitry 126 and readout circuitry 128. Readout circuitry 128 may also be referred to as column control circuitry, column decoder circuitry, processing circuitry, or image readout circuitry. Row control circuitry 126 may receive row addresses from control and processing circuitry 124 and supply corresponding row control signals to SPAD-based image pixels 202 over row control paths 130. One or more conductive lines such as column lines 132 may be coupled to each column of SPAD-based image pixels 202 in array 120. Column lines 132 may be used for reading out image signals from SPAD-based image pixels 202 and for supplying bias signal, such as bias voltages and/or bias currents, to SPAD-based image pixels 202. During pixel readout operations, a pixel row in array 120 may be selected using row control circuitry 126 and image signals generated by SPAD-based image pixels 202 in that pixel row may be read out along column lines 132.

Readout circuitry 128 may receive analog or digital image signals from SPAD-based image pixels 202 over column lines 132. Readout circuitry 128 may include sample-and-hold circuitry for sampling and temporarily storing image signals read out from array 120, amplifier circuitry, analog-to-digital conversion (ADC) circuitry, time-to-digital conversion (TDC) circuitry, bias circuitry, column memory, latch circuitry for selectively enabling or disabling the column circuitry, or other circuitry that is coupled to one or more columns of pixels in array 120 for operating SPAD-based image pixels 202 and for reading out signals from SPAD-based image pixels 202. ADC circuitry in readout circuitry 128 may convert analog pixel values received from array 120 into corresponding digital pixel values, which may also be referred to as digital image data or digital pixel data. Alternatively, ADC circuitry may be incorporated into each SPAD-based image pixel 202. Readout circuitry 128 may supply digital pixel data to control and processing circuitry 124 via path 125 for pixels in one or more pixel columns.

The example of SPAD-based semiconductor device 14 having readout circuitry to read out signals from the SPAD-based image pixels in a row-by-row manner is merely illustrative. In other embodiments, the readout circuitry in the image sensor may simply include digital pulse counting circuits coupled to each SPAD-based image pixel. Any other desired readout circuitry arrangement may be used.

In some embodiments, each SPAD-based image pixel 202 in array 120 may be a back-side illuminated (BSI) SPAD-based image pixel. In some embodiments, array 120 may be part of a multi-die arrangement in which SPAD-based image pixels 202 may be formed in a first substrate and some or all of the corresponding control and readout circuitry may be formed in a second and/or third substrate that may be included in a stack with the first substrate.

Because SPAD devices can detect a single incident photon of light, SPAD devices may be effective at imaging scenes with low light levels. Each SPAD device may detect how many photons are received within a given period of time. However, each time a photon is received and an avalanche current initiated, the SPAD device must be quenched and reset before being ready to detect another photon. As incident light levels increase, the dynamic range of the SPAD device may be limited by the reset time. For example, once incident light levels exceed a given level, the SPAD device may be triggered immediately upon being reset. Thus, to increase the dynamic range of a SPAD-based semiconductor device using SPAD-based image pixels, each SPAD-based image pixel may be implemented by a silicon photomultiplier (SiPM) having a plurality of microcells that each include a SPAD device. Readout circuitry for the SiPM may measure the combined output current from all of the SPAD-based microcells. In this way, the dynamic range of each SPAD-based image pixel of an imaging system may be increased.

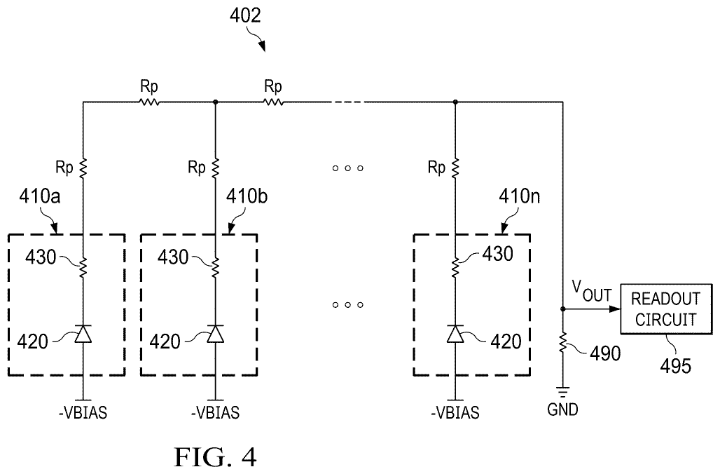

FIG. 4 illustrates a circuit diagram of silicon photomultiplier (SiPM) 402 in accordance with embodiments of the present disclosure. As shown in FIG. 4, SiPM 402 may include an N number of SPAD-based microcells, including microcell 410a, microcell 410b, through microcell 410n. For the purposes of the present disclosure, microcells 410a, 410b, through 410n may also be individually referred to as a microcell 410 or collectively referred to as microcells 410. An SiPM such as SiPM 402 may be implemented with any suitable N number of microcells 410. For example, an SiPM such as SiPM 402 may be implemented with a number of microcells 410 in the order of tens, hundreds, thousands, or more.

Microcells 410a, 410b, through 410n may each include single-photon avalanche diode 420 and quenching device 430. In some embodiments, quenching device 430 may be a passive quenching device such as a resistor. As shown in FIG. 4, each instance of microcell 410 may be coupled in parallel with each other between a negative bias supply-VBIAS and a load resistor 490 coupled to ground GND. The voltage of the negative bias supply-VBIAS may be a negative voltage sufficient to bias single-photon avalanche diode 420 beyond the reverse breakdown voltage of single-photon avalanche diode 420.

With single-photon avalanche diode 420 biased beyond its reverse breakdown voltage, an incident photon of light received by single-photon avalanche diode 420 may generate an electron and hole pair, which may in turn initiate an avalanche breakdown with additional carriers being generated. The avalanche multiplication may produce a current signal. The avalanche process may subsequently be stopped or quenched as the current generates a voltage drop across quenching device 430, thereby reducing the bias voltage across single-photon avalanche diode 420 below the reverse breakdown voltage of single-photon avalanche diode 420 and quenching the avalanche.

As shown in FIG. 4, load resistor 490 may receive the combined current from each microcell 410 in SiPM 402. A single output voltage VOUT may thus be developed by SiPM 402 and read by readout circuit 495. In this way, the dynamic range of a SPAD-based image pixel may be improved by implementing the SPAD-based image pixel with an SiPM. For example, each individual instance of microcell 410 in SiPM 402 may have an associated probability of an avalanche current being triggered when an incident photon is received. The probability of the avalanche current being triggered depends on both a first probability of an electron being created when a photon reaches the diode as well as a second probability of the electron triggering an avalanche current. The total probability of a photon triggering an avalanche current may be referred to as the photon-detection efficiency of the microcell. By grouping together multiple microcells 410 in SiPM 402, a more accurate measurement of the incoming incident light may be provided.

When grouping together multiple instances of microcell 410, various routing parasitics may be incurred as represented by parasitic resistors Rp shown in FIG. 4. As current signals are generated by one or more instances of microcells 410 at a given time, those current signals may cause voltage drops across various parasitic resistors Rp. The bias voltage for one or more other instances of microcells 410 may thus be reduced, thereby degrading the uniformity of the photon-detection efficiency (PDE) across SiPM 402 and across a SPAD-based semiconductor device in which a plurality of instances of SiPM 402 may be included.

The PDE uniformity of a SPAD-based semiconductor device, including numerous SPAD-based image pixels each implemented by an SiPM, may be improved by utilizing one or more current mirrors for biasing the single-photon avalanche diodes of individual SPAD-based microcells within an SiPM. In some embodiments, each microcell of an SiPM may include a single-photon avalanche diode, a quenching device coupled in series with the single-photon avalanche diode, and a current mirror configured to receive a current signal from the single-photon avalanche diode and to generate a microcell output current based on the current signal from the single-photon avalanche diode. In such embodiments, the respective microcell output currents may be summed together at a common output channel of the SiPM. The inclusion of the current mirror in each microcell may allow direct biasing of each microcell thereby reducing the negative affect that any parasitic routing resistances may have on PDE uniformity across the SiPM and across the SPAD-based semiconductor device in which the SiPM may be implemented. Further, the current mirror may serve as a buffer that decouples single-photon avalanche diode from the common output channel of the SiPM. In addition, the current mirror may be utilized to amplify the current signal from the single-photon avalanche diode of each microcell, thereby improving the electrical performance of each microcell and the SiPM.

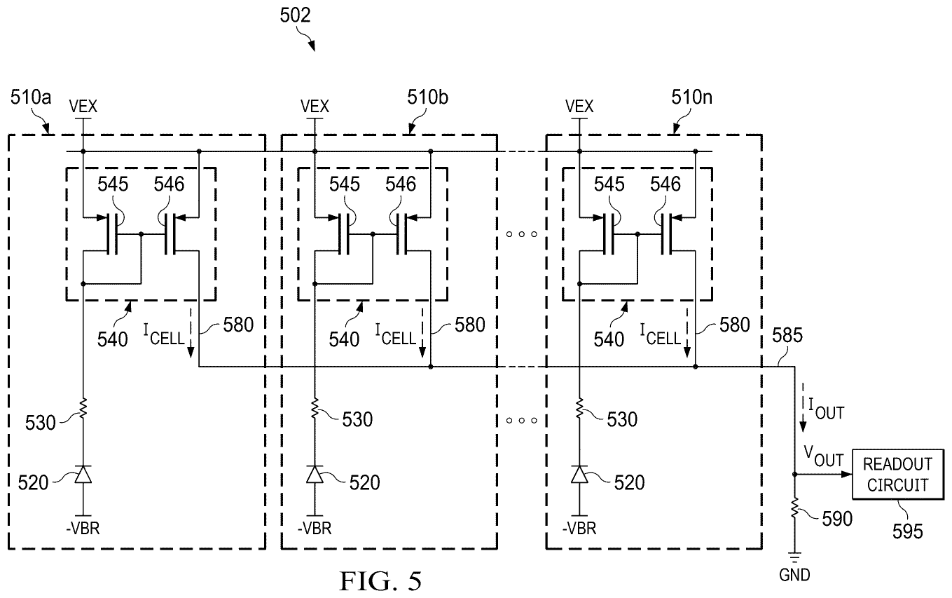

FIG. 5 illustrates a circuit diagram of silicon photomultiplier (SiPM) 502 in accordance with embodiments of the present disclosure. In some embodiments, each SPAD-based image pixel 202 of SPAD-based semiconductor device 14 described above with reference to FIG. 3 may be implemented with an instance of SiPM 502.

As shown in FIG. 5, SiPM 502 may include a plurality of microcells. For example, SiPM 502 may include an N number of SPAD-based microcells, including microcell 510a, microcell 510b, through microcell 510n. For the purposes of the present disclosure, microcells 510a, 510b, through 510n may also be individually referred to as a microcell 510 or collectively referred to as microcells 510. SiPM 502 may be implemented with any suitable N number of microcells 510. For example, SiPM 502 may be implemented with a number of microcells 510 in the order of tens, hundreds, thousands, or more.

As shown in FIG. 5, each of the plurality of microcells 510a, 510b, through 510n may include single-photon avalanche diode 520, quenching device 530, and current mirror 540. Single-photon avalanche diode 520 may have an anode coupled to a negative voltage bias supply-VBR and a cathode coupled to quenching device 530. In some embodiments, quenching device 530 may be a passive quenching device, such as a resistor, and may be coupled in series with single-photon avalanche diode 520. Specifically, quenching device 530 may be coupled in series between single-photon avalanche diode 520 and current mirror 540.

Current mirror 540 may include input transistor 545 and output transistor 546. In some embodiments, input transistor 545 and output transistor 546 may be p-type metal-oxide semiconductor field-effect transistors (p-type MOSFETs or PMOS transistors). Input transistor 545 and output transistor 546 may be configured such that output transistor 546 generates an output current that mirrors the current received by input transistor 545. For example, input transistor 545 may be coupled in a diode-coupled configuration with the drain and gate of input transistor 545 coupled together. The gate of output transistor 546 may be coupled to the drain and gate of input transistor 545. In addition, the respective sources of both input transistor 545 and output transistor 546 may be coupled together and to a positive voltage bias supply VEX.

In some embodiments, the negative voltage bias supply-VBR may be set to a negative voltage equal to the reverse breakdown voltage of single-photon avalanche diode 520. Further, the positive voltage bias supply VEX may be set to a positive voltage level sufficient to provide headroom for current mirror 540 and to provide an excess voltage bias above the reverse breakdown voltage of single-photon avalanche diode 520. The use of a large negative voltage for −VBR and a lesser magnitude positive voltage for VEX may provide the voltage difference required to bias single-photon avalanche diode 520 above its reverse breakdown point, while also allowing for the use of low-voltage transistors to implement input transistor 545 and output transistor 546 of current mirror 540.

With single-photon avalanche diode 520 biased above its reverse breakdown point, an incident photon of light received by single-photon avalanche diode 520 may generate an electron and hole pair, which may in turn initiate an avalanche breakdown with additional carriers being generated. The avalanche multiplication may produce a current signal. The avalanche process may subsequently be stopped or quenched as the current generates a voltage drop across quenching device 530, thereby reducing the bias voltage across single-photon avalanche diode 520 below its reverse breakdown voltage to quench the avalanche. The current signal produced by single-photon avalanche diode 520 during the avalanche may be received by current mirror 540. Current mirror 540 may be configured to generate a microcell output current ICELL based on the current from single-photon avalanche diode 520. Specifically, input transistor 545 may be configured to receive the current signal from single-photon avalanche diode 520, which output transistor 546 may mirror to generate the microcell output current ICELL at microcell output 580.

As shown in FIG. 5, the microcell output 580 of each of the plurality of microcells 510a, 510b, through 510n may be coupled to summation node 585. The microcell output current ICELL of each of the plurality of microcells 510a, 510b, through 510n may thus be summed together to form the output current IOUT of SiPM 502 at summation node 585. In some embodiments, SiPM 502 may also include resistor 590 which may be coupled to summation node 585 to receive the microcell output current ICELL from each of the plurality of microcells 510a, 510b, through 510n. Resistor 590 may thus generate an output voltage VOUT based on the sum of the microcell output currents from each of the plurality of microcells 510a, 510b, through 510n. In some embodiments, readout circuit 595 may read the output voltage VOUT. In other embodiments, resistor 590 may be omitted and readout circuit 595 may be configured to read the output current IOUT of SiPM 502 directly.

The design of the plurality of microcells 510a, 510b, through 510n may provide multiple advantages for SiPM 502. For example, each of the plurality of microcells 510a, 510b, through 510n may be directly biased by both the negative voltage bias supply-VBR and the positive voltage bias supply VEX. The negative parasitic effect that the avalanche current of one of the plurality of microcells 510a, 510b, through 510n may have on others from among the plurality of microcells 510a, 510b, through 510n may thus be eliminated or reduced. Further, for each of the plurality of microcells 510a, 510b, through 510n, current mirror 540 may serve as a buffer that decouples single-photon avalanche diode 520 from the common output channel of SiPM 502 at summation node 585. Single-photon avalanche diode 520 may thus be buffered from any output capacitance present at the output of SiPM 502. In addition, for each of the plurality of microcells 510a, 510b, through 510n, current mirror 540 may be configured to amplify the current from single-photon avalanche diode 520 to generate the microcell output current ICELL. In some embodiments, a first width-to-length ratio of a channel region of the output transistor 546 may be greater than a second width-to-length ratio of a channel region of input transistor 545. For example, output transistor 546 may be configured with a channel region that has a width-to-length ratio that is 2, 5, 10, or more, times larger than the width-to-length ratio of the channel region of input transistor 545. Output transistor 546 may thus generate a microcell output current ICELL current that is 2, 5, 10, or more, times larger than the current signal received by input transistor 545 from single-photon avalanche diode 520. Such amplification may provide a larger signal-to-noise ratio for readout circuit 595.

The performance of various examples of silicon photomultipliers (SiPMs) disclosed here may be further improved by including additional control circuitry that may control the enabling and disabling of each microcell of an SiPM. For example, in various examples disclosed herein, the microcells of an SiPM may include an enable transistor coupled in series with the single-photon avalanche diode of the microcell to enable and disable the current path of the single-photon avalanche diode. Various examples of microcells disclosed herein may further include a disable transistor that may be coupled between ground and the cathode of the single-photon avalanche diode. The disable transistor may thus reduce the bias voltage at the cathode of the single-photon avalanche diode, and thereby reduce the power consumption of the microcell during times when certain groups of microcells, or the SiPM as a whole, is disabled or otherwise unneeded by the imaging system.

In addition, various examples of microcells disclosed herein may include a pre-charge transistor. As described above, the dynamic range of a SPAD-based device may be limited in part by the time it takes for an avalanche current to be quenched and for the bias of the SPAD-based device to be reset before being ready to detect another photon. The pre-charge transistor may improve the dynamic range of the SiPM in which the microcell is included by rapidly charging up parasitic capacitance at the cathode of the single-photon avalanche diode to the intended bias voltage, thereby biasing the single-photon avalanche diode above its reverse breakdown voltage faster than would otherwise be accomplished via the current path from the positive voltage bias supply through the current mirror and quenching device. Accordingly, the use of a pre-charge transistor may improve the speed at which each microcell of the SiPM may be reset before being ready to detect another photon.

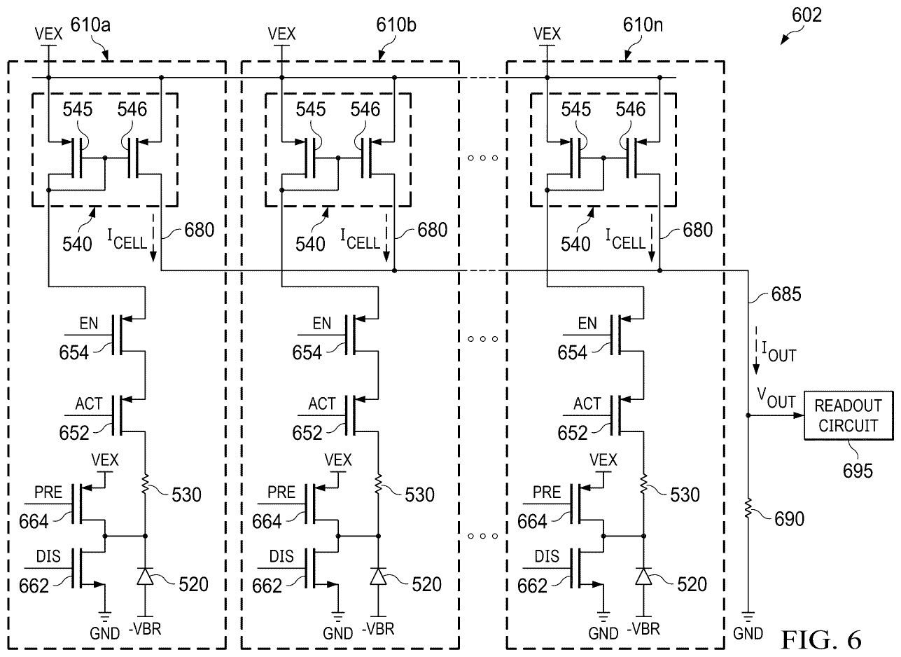

FIG. 6 illustrates a circuit diagram of silicon photomultiplier (SiPM) 602 in accordance with embodiments of the present disclosure. In some embodiments, each SPAD-based image pixel 202 of SPAD-based semiconductor device 14 described above with reference to FIG. 3 may be implemented with an instance of SiPM 602.

As shown in FIG. 6, SiPM 602 may include a plurality of microcells. For example, SiPM 602 may include an N number of SPAD-based microcells, including microcell 610a, microcell 610b, through microcell 610n. For the purposes of the present disclosure, microcells 610a, 610b, through 610n may also be individually referred to as a microcell 610 or collectively referred to as microcells 610. SiPM 602 may be implemented with any suitable N number of microcells 610. For example, SiPM 602 may be implemented with a number of microcells 610 in the order of tens, hundreds, thousands, or more.

As shown in FIG. 6, each of the plurality of microcells 610a, 610b, through 610n may include single-photon avalanche diode 520, quenching device 530, and current mirror 540. Single-photon avalanche diode 520, quenching device 530, and current mirror 540 may each operate within the plurality of microcells 610a, 610b, through 610n in a similar manner as described above with reference to FIG. 5 for the plurality of microcells 510a, 510b, through 510n. As described in further detail below, enable transistor 654 and quenching transistor 652 may be normally driven in an on-state during operation of the microcell, thereby enabling the current path between single-photon avalanche diode 520 and current mirror 540. A current signal produced by single-photon avalanche diode 520 during an avalanche may thus be received by current mirror 540. Current mirror 540 may generate a microcell output current ICELL based on the current from single-photon avalanche diode 520. Specifically, input transistor 545 may be configured to receive the current signal from single-photon avalanche diode 520, which output transistor 546 may mirror to generate the microcell output current ICELL at microcell output 680.

As also shown in FIG. 6, the plurality of microcells 610a, 610b, through 610n may include additional circuitry to enable, disable, pre-charge, and actively quench single-photon avalanche diode 520. For example, as described in further detail directly below, each of the plurality of microcells 610a, 610b, through 610n may include one or more of enable transistor 654, quenching transistor 652, pre-charge transistor 664, and disable transistor 662.

Enable transistor 654 may be coupled in series with single-photon avalanche diode 520 and configured to enable a current path between single-photon avalanche diode 520 and current mirror 540. In some embodiments, enable transistor 654 may be a PMOS transistor. The source of enable transistor 654 may be coupled to current mirror 540, and specifically to the gate and the drain of input transistor 545 of current mirror 540. The drain of enable transistor 654 may be coupled to quenching transistor 652, which as described in further detail below, may in turn be coupled in series with the current path formed by quenching device 530 and single-photon avalanche diode 520. Although enable transistor 654 is shown in the embodiment of FIG. 6 as being coupled indirectly to quenching device 530 and single-photon avalanche diode 520, enable transistor 654 may be coupled either directly to or indirectly to, and in series with, single-photon avalanche diode 520 and/or quenching device 530 to enable a current path between single-photon avalanche diode 520 and current mirror 540. For example, enable transistor 654 may receive a logic low enable signal EN at its gate to place enable transistor 654 in an on-state and thereby enable the current path between single-photon avalanche diode 520 and current mirror 540. Conversely, a logic high signal at the gate of enable transistor 654 may disable the current path between single-photon avalanche diode 520 and current mirror 540.

Quenching transistor 652 may be coupled in series between single-photon avalanche diode 520 and current mirror 540. In some embodiments, quenching transistor 652 may be a PMOS transistor. The source of quenching transistor 652 may be coupled to the drain of enable transistor 654, which as described above, may in turn be coupled to current mirror 540. The drain of quenching transistor 652 may be coupled to quenching device 530, which may in turn be coupled in series with avalanche diode 520. Although quenching transistor 652 is shown in the embodiment of FIG. 6 as being coupled indirectly to single-photon avalanche diode 520 via quenching device 530, quenching transistor 652 may be coupled either directly or indirectly to, and in series with, single-photon avalanche diode 520. In some embodiments, quenching transistor 652 may be configured to provide active quenching of single-photon avalanche diode 520. For example, the gate of quenching transistor 652 may be normally held at a logic low level to keep quenching transistor 652 in an on-state. Then, after an avalanche has been initiated and detected in single-photon avalanche diode 520, a logic high active quench signal ACT may be applied to the gate of quenching transistor 652 to place the quenching transistor 652 in an off-state. By placing quenching transistor 652 in an off-state, the voltage bias of single-photon avalanche diode 520 may rapidly drop below the reverse breakdown voltage of single-photon avalanche diode 520, thereby quenching the avalanche. After the avalanche has been quenched, the gate of quenching transistor 652 may be returned to its normal logic low level.

In some embodiments, quenching transistor 652 may operate in conjunction with quenching device 530 to quench the avalanche of single-photon avalanche diode 520. For example, quenching transistor 652 may provide active quenching as described directly above, while quenching device 530 may in some embodiments be implemented by a resistor that may provide passive quenching as described above with reference to FIG. 5. In other embodiments, quenching transistor 652 may be implemented in place of quenching device 530. In such other embodiments, quenching device 530 may be omitted and quenching transistor 652 may be coupled directly to single-photon avalanche diode 520.

Pre-charge transistor 664 may be configured to pre-charge single-photon avalanche diode 520 at a bias voltage above the reverse breakdown voltage of single-photon avalanche diode 520. For example, pre-charge transistor 664 may be a PMOS transistor with a source coupled to the positive voltage bias supply VEX, a drain coupled to the cathode of single-photon avalanche diode 520, and a gate coupled to receive a pre-charge signal PRE. As described above, the dynamic range of a SPAD-based device may be limited in part by the time it takes for an avalanche current to be quenched and for the bias of the SPAD-based device to be reset before being ready to detect another photon. As shown in FIG. 6, each instance of microcell 610a, 610b, through 610n may include pre-charge transistor 664 to improve this reset time, thereby improving the dynamic range of SiPM 602 and the image sensor in which SiPM 602 may be implemented. For example, after an avalanche has been detected and quenched, a logic low pre-charge signal PRE may be applied for a short duration to the gate of pre-charge transistor 664 to drive pre-charge transistor 664 in an on-state for a short duration of time. During the on-state of pre-charge transistor 664, the cathode of single-photon avalanche diode 520 may be charged up to the bias voltage equal to VEX, thereby biasing single-photon avalanche diode 520 above its reverse breakdown voltage. Pre-charge transistor 664 may charge up the parasitic capacitance, and thus raise the bias voltage, at the cathode of single-photon avalanche diode 520 faster than would otherwise be accomplished via the current path from VEX through current mirror 540, enable transistor 654, quenching transistor 652, and quenching device 530. After pre-charging the cathode of single-photon avalanche diode 520, pre-charge transistor 664 may be driven in an off-state so as to not interfere with the detection of a subsequent avalanche current in single-photon avalanche diode 520.

Disable transistor 662 may be coupled to the cathode of single-photon avalanche diode 520 and may be configured to disable single-photon avalanche diode 520. For example, disable transistor 662 may be configured to reduce the bias voltage applied to single-photon avalanche diode 520, and thereby disable operation of the microcell. In some embodiments, disable transistor 662 may be an n-type metal-oxide semiconductor field-effect transistor (n-type MOSFET or NMOS transistor). And in some embodiments, disable transistor 662 may have a drain coupled to the cathode of single-photon avalanche diode 520, a source coupled to ground GND, and a gate coupled to receive a disable signal DIS. During operation of SiPM 602, or an imaging system in which SiPM 602 is implemented, it may be desirable to disable a group of one or more microcells from among the plurality of microcells 610a, 610b, through 610n, when either not needed or otherwise not in use by the imaging system. During such times, a logic high disable signal DIS may be applied to the gate of disable transistor 662 to drive disable transistor 662 in an on-state. Disable transistor 662 may thus ensure that the voltage at the cathode of single-photon avalanche diode 520 does not rise above, for example, ground GND. More specifically, disable transistor 662 may ensure that the bias voltage across single-photon avalanche diode 520 does not exceed the reverse breakdown voltage of single-photon avalanche diode 520. Disable transistor 662 may thus prevent, or reduce the likelihood, of single-photon avalanche diode 520 from entering avalanche in response to an incident photon of light. The disable transistor 662 of each microcell 610a, 610b, through 610n may thus reduce the power consumption of one or more microcells from among the plurality of microcells 610a, 610b, through 610n, when either not needed or otherwise not in use by the imaging system.

As shown in FIG. 6, the microcell output 680 of each of the plurality of microcells 610a, 610b, through 610n may be coupled to summation node 685. The microcell output current ICELL of each of the plurality of microcells 610a, 610b, through 610n may thus be summed together to form the output current IOUT of SiPM 602 at summation node 685. In some embodiments, SiPM 602 may also include resistor 690 which may be coupled to summation node 685 to receive the microcell output current ICELL from each of the plurality of microcells 610a, 610b, through 610n. Resistor 690 may thus generate an output voltage VOUT based on the sum of the individual microcell output currents ICELL from each of the plurality of microcells 610a, 610b, through 610n. In some embodiments, readout circuit 695 may read the output voltage VOUT. In other embodiments, resistor 690 may be omitted and readout circuit 695 may be configured to read the output current IOUT of SiPM 602 directly.

The design of the plurality of microcells 610a, 610b, through 610n may provide multiple advantages for SiPM 602. For example, each of the plurality of microcells 610a, 610b, through 610n may be directly biased by both the negative voltage bias supply-VBR and the positive voltage bias supply VEX. The negative parasitic effect that the avalanche current of one of the plurality of microcells 610a, 610b, through 610n may have on others from among the plurality of microcells 610a, 610b, through 610n may thus be eliminated or reduced. Further, for each of the plurality of microcells 610a, 610b, through 610n, current mirror 540 may serve as a buffer that decouples single-photon avalanche diode 520 from the common output channel of SiPM 602 at summation node 685. Single-photon avalanche diode 520 may thus be buffered from any output capacitance present at the output of SiPM 602. In addition, for each of the plurality of microcells 610a, 610b, through 610n, current mirror 540 may be configured to amplify the current from single-photon avalanche diode 520 to generate the microcell output current ICELL. In some embodiments, a first width-to-length ratio of a channel region of the output transistor 546 may be greater than a second width-to-length ratio of a channel region of input transistor 545. For example, output transistor 546 may be configured with a channel region that has a width-to-length ratio that is 2, 5, 10, or more, times larger than the width-to-length ratio of the channel region of input transistor 545. Output transistor 546 may thus generate a microcell output current ICELL current that is 2, 5, 10, or more, times larger than the current signal received by input transistor 545 from single-photon avalanche diode 520. Such amplification may provide a larger signal-to-noise ratio for readout circuit 695.

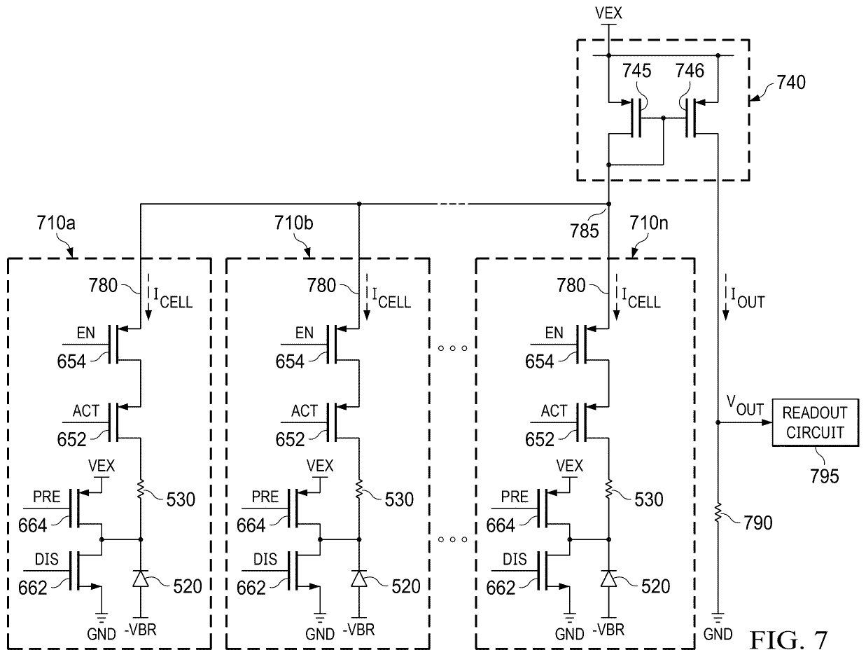

FIG. 7 illustrates a circuit diagram of silicon photomultiplier (SiPM) 702 in accordance with embodiments of the present disclosure. In some embodiments, each SPAD-based image pixel 202 of SPAD-based semiconductor device 14 described above with reference to FIG. 3 may be implemented with an instance of SiPM 702.

As shown in FIG. 7, SiPM 702 may include current mirror 740 and an N number of SPAD-based microcells, including for example microcell 710a, microcell 710b, through microcell 710n. For the purposes of the present disclosure, microcells 710a, 710b, through 710n may also be individually referred to as a microcell 710 or collectively referred to as microcells 710. SiPM 702 may be implemented with any suitable N number of microcells 710. For example, SiPM 702 may be implemented with a number of microcells 710 in the order of tens, hundreds, thousands, or more.

In some embodiments, each of the plurality of microcells 710a, 710b, through 710n may have a microcell output 780 coupled to a summation node 785 of SiPM 702. Each of the plurality of microcells 710a, 710b, through 710n, may include single-photon avalanche diode 520, quenching device 530, as well as enable transistor 654, quenching transistor 652, pre-charge transistor 664, and disable transistor 662. Single-photon avalanche diode 520, quenching device 530, as well as enable transistor 654, quenching transistor 652, pre-charge transistor 664, and disable transistor 662, may each operate in a similar manner as described above with reference to FIG. 5 and FIG. 6. However, as shown in FIG. 7, rather than including a current mirror within each microcell, microcells 710a, 710b, 710c, may in some embodiments output a current signal from its single-photon avalanche diode 520 as the microcell output current ICELL at microcell output 780. Thus, for the purposes of the present disclosure, quenching transistor 652 may be referred to as being coupled in series between single-photon avalanche diode 520 and the microcell output 780. Likewise, enable transistor 654 may be referred to as being coupled in series between single-photon avalanche diode 520 and the microcell output 780. The microcell output 780 of each of the plurality of microcells 710a, 710b, through 710n may then be coupled together at summation node 785. And as described in further detail below, current mirror 740 may mirror the sum of the respective microcell output currents received at summation node 785.

Current mirror 740 may be coupled to summation node 785 and may be configured to generate an SiPM output current IOUT based on a sum of the respective microcell output currents received at summation node 785. For example, current mirror 740 may include input transistor 745 and output transistor 746. In some embodiments, input transistor 745 and output transistor 746 may be PMOS transistors. Input transistor 745 and output transistor 746 may be configured such that output transistor 746 generates an output current that mirrors the current received by input transistor 745. For example, input transistor 745 may be coupled in a diode-coupled configuration with the drain and gate of input transistor 745 coupled together. The gate of output transistor 746 may be coupled to the drain and gate of input transistor 745. In addition, the respective sources of both input transistor 745 and output transistor 746 may be coupled together and to the positive voltage bias supply VEX. Current mirror 740 may thus mirror the sum of the respective microcell output currents ICELL received at summation node 785 to generate the SiPM output current IOUT.

Current mirror 740 may be configured to amplify the sum of the respective microcell output currents ICELL received at summation node 785 to generate the SiPM output current IOUT. In some embodiments, a first width-to-length ratio of a channel region of the output transistor 746 may be greater than a second width-to-length ratio of a channel region of input transistor 745. For example, output transistor 746 may be configured with a channel region that has a width-to-length ratio that is 2, 5, 10, or more, times larger than the width-to-length ratio of the channel region of input transistor 745. Output transistor 746 may thus generate an SiPM output current IOUT that is 2, 5, 10, or more, times larger than the sum of the respective microcell output currents received by input transistor 545 at summation node 785. Such amplification may provide a larger signal-to-noise ratio for readout circuit 795.

In some embodiments, SiPM 702 may also include resistor 790 which may be coupled to the output of current mirror 740 to receive the SiPM output current IOUT. Resistor 790 may thus generate an output voltage VOUT based on the SiPM output current IOUT. In some embodiments, readout circuit 795 may read the output voltage VOUT. In other embodiments, resistor 790 may be omitted and readout circuit 795 may be configured to read the SiPM output current IOUT of SiPM 702 directly.

In some embodiments, the negative voltage bias supply-VBR may be set to a negative voltage equal to the reverse breakdown voltage of single-photon avalanche diode 520. Further, the positive voltage bias supply VEX may be set to a positive voltage level sufficient to provide headroom for current mirror 740 and to provide an excess voltage bias above the reverse breakdown voltage of single-photon avalanche diode 520. The use of a large negative voltage for −VBR and a lesser magnitude positive voltage for VEX may provide the voltage difference required to bias single-photon avalanche diode 520 above its reverse breakdown voltage, while also allowing for the use of low-voltage transistors to implement input transistor 745 and output transistor 746 of current mirror 740.

The design of SiPM 702, including current mirror 740 and the plurality of microcells 710a, 710b, through 710n, may provide multiple advantages for SiPM 702. For example, current mirror 740 may serve as a buffer that decouples the single-photon avalanche diode 520 in each of the plurality of microcells 710a, 710b, through 710n from the common output channel of SiPM 702. The single-photon avalanche diode 520 for each of the plurality of microcells 710a, 710b, through 710n may thus be buffered from any output capacitance present at the output of SiPM 702. In addition, current mirror 740 may as described above be configured to amplify the sum of the individual microcell output currents ICELL to general the SiPM output current IOUT. Such amplification may provide a larger signal-to-noise ratio for readout circuit 795.

Moreover, during operation of SiPM 702, or an imaging system in which SiPM 702 is implemented, it may be desirable to disable a group of one or more microcells from among the plurality of microcells 710a, 710b, through 710n, when either not needed or otherwise not in use by the imaging system. During such times, and for any one or more of a selected group of microcells, a logic high disable signal DIS may be applied to drive disable transistor 662 in an on-state. Disable transistor 662 may thus ensure that the voltage at the cathode of single-photon avalanche diode 520 does not rise above, for example, ground GND. More specifically, disable transistor 662 may ensure that the bias voltage across single-photon avalanche diode 520 does not exceed the reverse breakdown voltage of single-photon avalanche diode 520. Disable transistor 662 may thus prevent, or reduce the likelihood, of single-photon avalanche diode 520 from entering avalanche in response to an incident photon of light. The disable transistor 662 of each microcell 710a, 710b, through 710n may thus reduce the power consumption of any disabled microcell when either not needed or otherwise not in use by the imaging system.

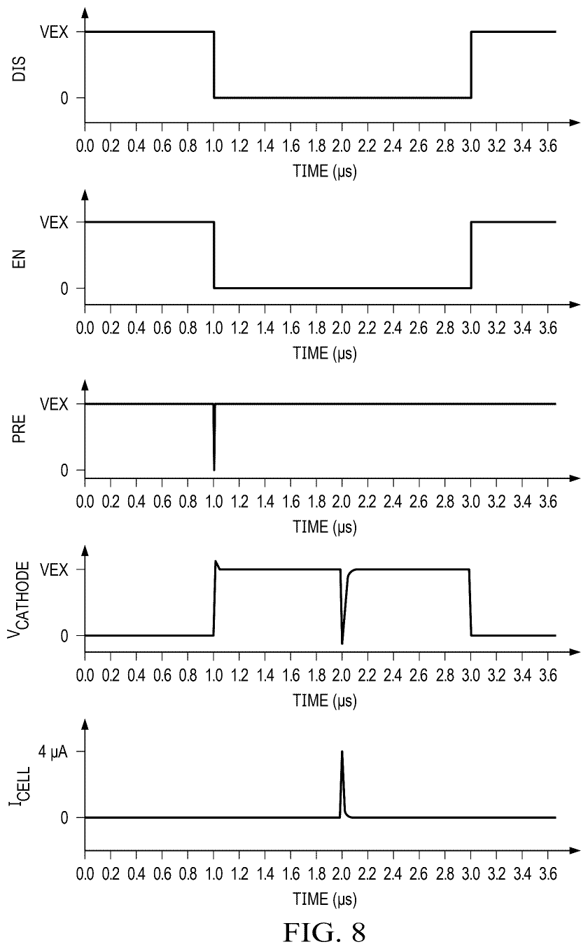

FIG. 8 illustrates example waveforms of signals within a SPAD-based microcell in accordance with embodiments of the present disclosure. The waveforms of FIG. 7 illustrate, for example, signals within each of the plurality of microcells 710a, 710b, through 710n, described above with reference to FIG. 7.

As shown in FIG. 8, and specifically at a time of 1 μs in FIG. 8, the disable signal DIS may be transitioned from a logic high state to a logic low state to drive disable transistor 662 in an off-state. After transitioning disable transistor 662 to an off-state, the single-photon avalanche diode 520 may thereafter be pre-charged and the microcell may be enabled for detection. For example, when the disable signal DIS is transitioned low, the pre-charge signal PRE may be pulsed low for a short duration to drive pre-charge transistor 664 in an on-state for a short duration of time. Thus, the cathode voltage V_{CATHODE} of single-photon avalanche diode 520 may be rapidly charged up to or near the voltage level of positive voltage bias supply VEX. With the anode of single-photon avalanche diode 520 held at the negative voltage bias supply-VBR, the rapid pre-charge of the cathode voltage V_{CATHODE} of single-photon avalanche diode 520 may provide a rapid biasing of single-photon avalanche diode 520 at a voltage level greater than its reverse breakdown voltage. After pre-charging the cathode of single-photon avalanche diode 520, pre-charge transistor 664 may be returned to an off-state so as to not interfere with the detection of a subsequent avalanche current in single-photon avalanche diode 520. Subsequently, the enable signal EN may be transitioned from a logic high state to a logic low state to drive enable transistor 654 in an on-state, and thereby enable the microcell for the detection. Although not expressly shown in FIG. 8, quenching transistor 652 may also be driven in an on-state, beginning at least at a time of 1 us in FIG. 8, to further allow the microcell to operate in an enabled state.

A photon of light may be received by single-photon avalanche diode 520 as shown, for example, at a time of 2 us in FIG. 8. With single-photon avalanche diode 520 biased above its reverse breakdown voltage, an incident photon of light received by single-photon avalanche diode 520 may generate an electron and hole pair, which may in turn initiate an avalanche breakdown with additional carriers being generated. The avalanche multiplication may produce a current signal that may be output from the microcell as the microcell output current ICELL. The current generated by single-photon avalanche diode 520 and output as the microcell output current ICELL may in turn cause a voltage drop across quenching device 530 and/or quenching transistor 652. Accordingly, the cathode voltage V_{CATHODE} of single-photon avalanche diode 520 may drop, thereby reducing the bias voltage across single-photon avalanche diode 520 below its breakdown voltage to quench the avalanche. As the avalanche is quenched, the current generated by single-photon avalanche diode 520 and output as the microcell output current ICELL may return to zero and the cathode voltage V_{CATHODE} may return to a bias level approaching VEX.

One or more of the plurality of microcells 710a, 710b, through 710n may be disabled when not in use by the imaging system in which SiPM 702 is implemented. As shown for example at a time of 3 us in FIG. 8, the enable signal EN may be returned high to drive enable transistor 654 in an off-state and thereby disable the current path of single-photon avalanche diode 520. In addition, the disable signal DIS may also be forced high to drive disable transistor 662 in an on-state state and thereby discharge the cathode voltage V_{CATHODE} of single-photon avalanche diode 520 to ground GND. By discharging the cathode voltage V_{CATHODE} of single-photon avalanche diode 520 to ground GND, the total bias applied across single-photon avalanche diode 520 may be reduced, and the chances of single-photon avalanche diode 520 entering avalanche in response to an incident photon of light may be reduced. The power consumption of the microcell may thus be reduced while in the disabled state.

Although examples have been described above, other modifications and variations may be made from this disclosure without departing from the spirit and scope of these examples. The above descriptions of various embodiments illustrate the principles of the invention. Numerous variations and modifications will become apparent to those skilled in the art based on the above disclosure. The following claims are intended to embrace all such variations and modifications.

What is claimed is:

1. A silicon photomultiplier (SiPM) comprising:
a plurality of microcells coupled to a summation node of the SiPM, each of the plurality of microcells comprising:
a single-photon avalanche diode;
a passive quenching device coupled in series with the single-photon avalanche diode; and
a current mirror configured to generate a microcell output current based on a current from the single-photon avalanche diode.

2. The SiPM of claim 1, further comprising a resistor coupled to the summation node to receive the microcell output current from each of the plurality of microcells and to generate an output voltage.

3. The SiPM of claim 1, wherein the current mirror is configured to amplify the current from the single-photon avalanche diode to generate the microcell output current.

4. The SiPM of claim 1, wherein each of the plurality of microcells further includes a pre-charge transistor configured to pre-charge the single-photon avalanche diode at a bias voltage above a reverse breakdown voltage of the single-photon avalanche diode.

5. The SiPM of claim 1, wherein each of the plurality of microcells further includes a quenching transistor coupled in series between the single-photon avalanche diode and the current mirror.

6. The SiPM of claim 1, wherein each of the plurality of microcells further includes a disable transistor coupled to a cathode of the single-photon avalanche diode and configured to disable the single-photon avalanche diode.

7. The SiPM of claim 1, wherein each of the plurality of microcells further includes an enable transistor coupled in series with the single-photon avalanche diode and configured to enable a current path between the single-photon avalanche diode and the current mirror.

8. A silicon photomultiplier (SiPM) comprising:
a plurality of microcells each having a microcell output coupled to a summation node of the SiPM, each of the plurality of microcells comprising:
a single-photon avalanche diode; and
a passive quenching device coupled in series with the single-photon avalanche diode; and
a current mirror coupled to the summation node and configured to generate an SiPM output current based on a sum of microcell output currents received at the summation node.

9. The SiPM of claim 8, further comprising a resistor coupled to the current mirror and configured to generate an output voltage based on the SiPM output current.

10. The SiPM of claim 8, wherein the current mirror is configured to amplify the sum of microcell output currents received at the summation node to generate the SiPM output current.

11. The SiPM of claim 8, wherein each of the plurality of microcells further includes a pre-charge transistor configured to pre-charge the single-photon avalanche diode at a bias voltage above a reverse breakdown voltage of the single-photon avalanche diode.

12. The SiPM of claim 8, wherein each of the plurality of microcells further includes a quenching transistor coupled in series between the single-photon avalanche diode and the microcell output.

13. The SiPM of claim 8, wherein each of the plurality of microcells further includes a disable transistor coupled to a cathode of the single-photon avalanche diode and configured to disable the single-photon avalanche diode.

14. The SiPM of claim 8, wherein each of the plurality of microcells further includes an enable transistor coupled in series with the single-photon avalanche diode and configured to enable a current path between the single-photon avalanche diode and the microcell output.

15. An imaging system comprising:
an image processing circuit; and
a semiconductor device communicatively coupled to the image processing circuit and comprising a plurality of silicon photomultipliers (SiPM), each SiPM comprising:
a plurality of microcells each having a microcell output coupled to a summation node of the SiPM, each of the plurality of microcells comprising:
a single-photon avalanche diode; and
a passive quenching device coupled in series with the single-photon avalanche diode; and
a current mirror coupled to the summation node and configured to generate an SiPM output current based on a sum of microcell output currents received at the summation node.

16. The imaging system of claim 15, wherein:
the current mirror includes an input transistor and an output transistor; and
a first width-to-length ratio of a channel region of the output transistor is greater than a second width-to-length ratio of a channel region of the input transistor.

17. The imaging system of claim 15, wherein each of the plurality of microcells further includes a pre-charge transistor coupled to a cathode of the single-photon avalanche diode and configured to pre-charge the single-photon avalanche diode at a bias voltage above a reverse breakdown voltage of the single-photon avalanche diode.

18. The imaging system of claim 15, wherein each of the plurality of microcells further includes a quenching transistor coupled in series between the single-photon avalanche diode and the microcell output and configured to provide active quenching of the single-photon avalanche diode.

19. The imaging system of claim 15, wherein each of the plurality of microcells further includes a disable transistor coupled to a cathode of the single-photon avalanche diode and configured to reduce a bias voltage applied to the single-photon avalanche diode.

20. The imaging system of claim 15, wherein each of the plurality of microcells further includes an enable transistor coupled in series with the single-photon avalanche diode and configured to enable a current path between the single-photon avalanche diode and the microcell output.
